(19) United States
(12) Patent Application Publication
(10) Pub. No.: US 2011/0079045 A1
(43) Pub. Date: Apr. 7, 2011

(54) ADJUSTABLE BRACELET

(76) Inventor: Van Bielkiewicz, Port Allen, LA (US)

(21) Appl. No.: 12/574,583

(22) Filed: Oct. 6, 2009

(51) Int. Cl. G06K 19/00; A44C 5/00; A44C 5/18; A44C 15/00; G06K 19/06

(52) U.S. Cl. 63/1.13; 63/3.2; 235/487; 235/492

(57) ABSTRACT

An adjustable bracelet includes an adjustable main portion adapted to be worn on a human wrist. An electronic charity identifier is attached to the main portion. The bracelet is adapted to hold a dispensing lever of a fluid dispensing pump in an open position.

### FIELD OF THE INVENTION

The field of this invention is bracelets, and in particular the field is adjustable bracelets with electronic identifiers.

### BACKGROUND

When pumping gas at a gas station pump, it is convenient for the customer to have a device to hold the dispensing lever on the pump handle in the open position, rather than the holding the lever the entire time gasoline is dispensed. Customers may not want to stand outside their cars in the rain or snow for long periods of time. Safety may also be an issue at night. Many pumps have such a device on them, but they are often broken. Separate devices exist to hold the lever in an open position, but they are often cumbersome and customers may forget to bring them when buying gas.

Merchants may offer to donate a percentage of their sales to different charities in an effort to attract customers. They may allow customer selection of the charity to receive the donation. When a sale is made outside the physical store, at a gas pump for example, it may be difficult to allow the customer this choice and to record the choice. Some charities have cards with magnetic or bar codes that allow the selection to be read automatically. The customer may forget these cards when buying gas.

### SUMMARY OF THE INVENTION

An adjustable bracelet includes an adjustable main portion adapted to be worn on a human wrist. An electronic charity identifier is attached to the main portion. The bracelet is adapted to hold a dispensing lever of a fluid dispensing pump in an open position.

In another embodiment, an adjustable bracelet includes an adjustable main portion adapted to be worn on a human wrist. The main portion includes an electronic charity identifier. The bracelet is adapted to hold a dispensing lever of a fluid dispensing pump in an open position.

### BRIEF DESCRIPTION OF THE DRAWINGS

The drawings, when considered in connection with the following description, are presented for the purpose of facilitating an understanding of the subject matter sought to be protected.

FIG. 1A depicts an inside view of an exemplary embodiment of an adjustable bracelet.

FIG. 1B depicts an outside view of an exemplary embodiment of the adjustable bracelet.

FIG. 1C depicts an expanded view of a portion of an exemplary embodiment of the adjustable bracelet.

FIG. 1D depicts a cross section of an exemplary embodiment of the adjustable bracelet along Axis A in FIG. 1C.

FIG. 2A depicts an exemplary embodiment of an adjustable bracelet.

FIG. 2B depicts an exemplary embodiment of an adjustable bracelet.

FIG. 2C depicts an exemplary embodiment of an adjustable bracelet.

FIG. 3A depicts an outside view of an exemplary embodiment of an adjustable bracelet.

FIG. 3B depicts an inside view of a portion of an exemplary embodiment of the adjustable bracelet.

FIG. 4A depicts an exemplary embodiment of a fluid dispensing pump with an embodiment of the adjustable bracelet holding a dispensing lever.

FIG. 4B depicts an exemplary embodiment of a fluid dispensing pump with another embodiment of the adjustable bracelet holding a dispensing lever.

FIG. 4C depicts an exemplary embodiment of a fluid dispensing pump with another embodiment of the adjustable bracelet holding a dispensing lever.

### DETAILED DESCRIPTION

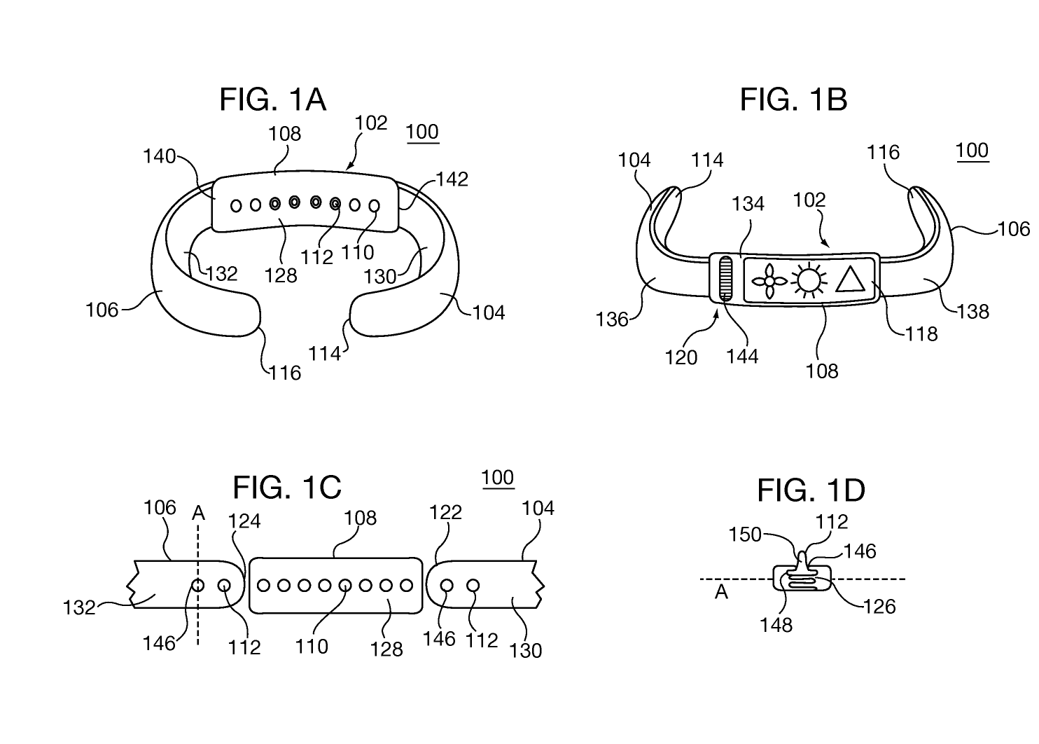

FIGS. 1-4 illustrate several embodiments of an adjustable bracelet. The purpose of these figures and the related descriptions is merely to aid in explaining the principles of the invention. Thus, the figures and descriptions should not be considered as limiting the scope of the invention to the embodiments shown herein. Other embodiments of adjustable bracelets may be created which follow the principles of the invention as taught herein, and these embodiments are intended to be included within the scope of the patent.

With reference to FIGS. 1A, 1B, 1C, and 1D, one embodiment of an adjustable bracelet 100 is depicted. The bracelet 100 includes a main portion 102. The main portion 102 includes a center portion 108, a first side portion 104, and a second side portion 106.

The center portion 108 is an elongated hollow member with a generally rectangular cross section with somewhat rounded corners. The center portion 108 may be slightly curved to better fit a human wrist. The center portion 108 includes an inside surface 128, an outside surface 134, a first end 140, and a second end 142. The inside surface 128 includes a plurality of apertures 110. The first end 140 and the second end 142 are open allowing access to the inside of the center portion 108. A decorative element 118 and an electronic charity identifier 120 are attached to the outside surface 134.

In the embodiment depicted, the decorative element 118 includes an enamel pictorial display. In alternative embodiments the decorative element 118 may include any pictorial, sculptural, or other element that a wearer would find decorative. In some embodiments the bracelet 100 will not include any distinct decorative element 118, but may have a smooth surface. In other embodiments the decorative element 118 may include a charm or a design etched into the surface of the bracelet 100. The decorative element 118 may be removable from the bracelet 100, or the decorative element 118 may be an integral part of the bracelet 100. The decorative element 118 may include the coloring of the bracelet 100, or the surface texture of the bracelet 100 or a portion of the bracelet 100.

The electronic charity identifier 120 is adapted to generate a signal indicative of a predetermined charity. In the depicted embodiment the identifier 120 is a bar code 144. The bar code 144 may include any optical machine-readable representation of data that would be known by an ordinary person skilled in the art now or in the future. For example, one embodiment of the bar code 144 may represent data in the widths and the spacing of parallel lines. In another embodiment of the bar code 144, data may be represented in patterns of squares, dots, hexagons or other geometric patterns. A reader (not shown) generates a signal as a function of the bar code 144 indicative of a charity associated with the bar code 144.

Merchants may use the donation of a portion of sales to a charity as a marketing tool. Customers who appreciate that the merchant is donating to a charity they support may be more likely to buy products from the merchant. The merchant may allow the customer to select from a group of charities the recipient of the donation from their sale. When a sale is made electronically, such as gas purchased with a credit card at the gas pump, it may be difficult to record the customer's charity selection.

Customers may be able to purchase or obtain bracelets 100 with a variety of bar codes 144. Each distinct bar code 144 may be adapted to generate a signal indicative of a certain charity. The customer may purchase or obtain the bracelet 100 with the bar code 144 associated with the customer's charity selection. The reader may be located on the gas pump or the location where the customer pays. When the customer purchases gas or other items electronically, the charity he/she wishes to receive the donation associated with the purchase may be recorded. In addition to gas pumps, the identifier 120 may be used at other electronic purchase stations such as self-check-out stations at grocery stores.

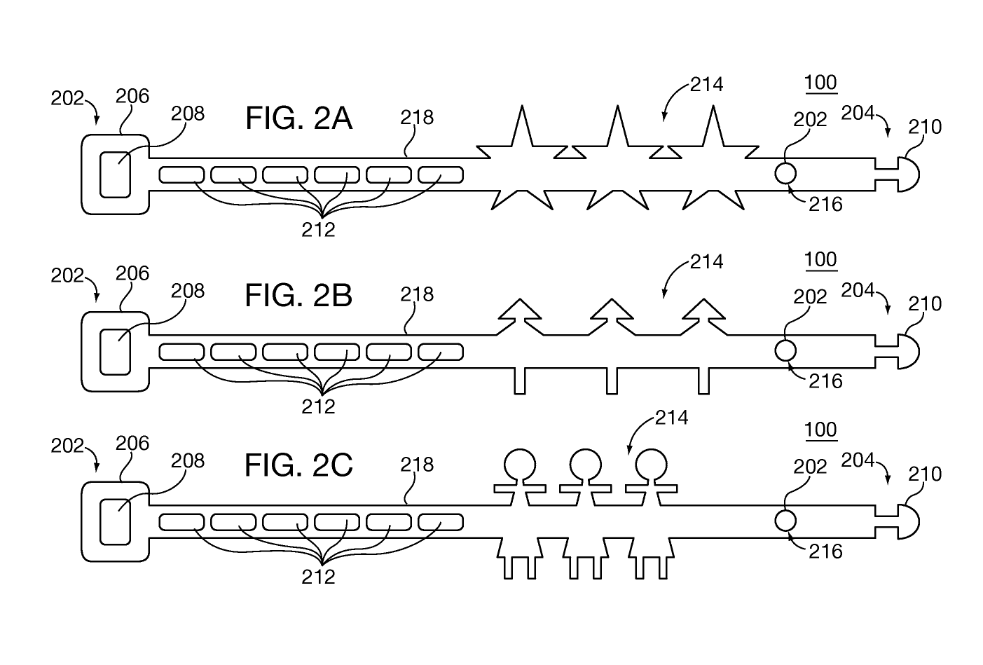

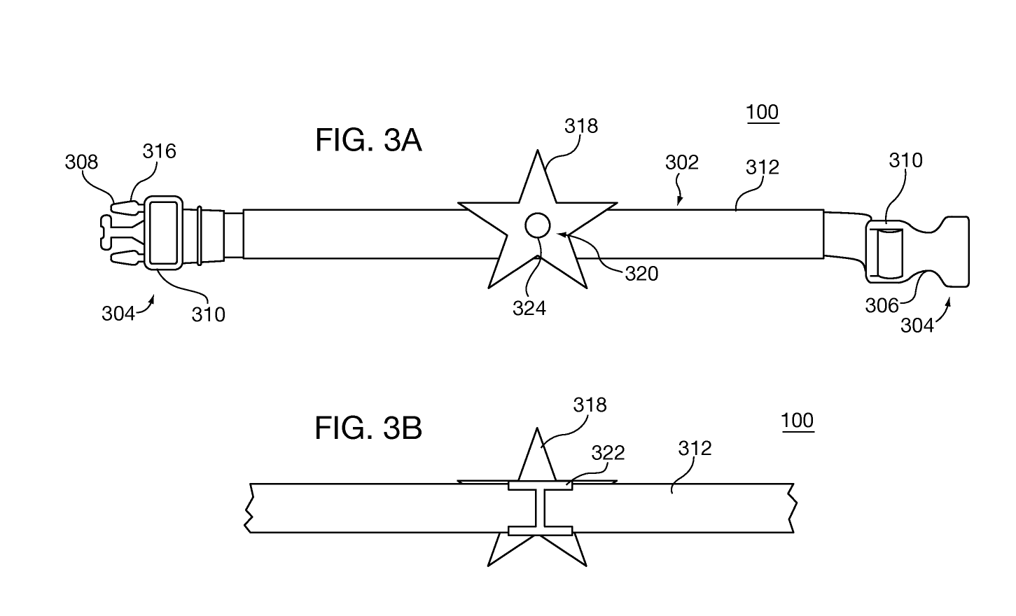

In other embodiments the electronic charity identifier 120 may include a low frequency RFID tag 216, 324 (shown in relation to FIGS. 2A, 2B, 2C, and 3A). RFID (radio frequency identification) is a technology that incorporates the use of electromagnetic or electrostatic coupling in the radio frequency portion of the electromagnetic spectrum to uniquely identify an object, animal, or person. An advantage of the RFID tag 216, 324 embodiment of the identifier 120 is that it does not require direct contact or line-of-sight scanning. An RFID system (not shown) consists of three components: an antenna and transceiver (often combined into one reader) and a transponder (the tag 216, 324). The antenna uses radio frequency waves to transmit a signal that activates the tag 216, 324. When activated, the tag 216, 324 transmits data back to the antenna—a signal indicative of a predetermined charity. This data will interface with a merchant's other systems to cause a percentage of the sale to be donated to the predetermined charity. Low-frequency RFID systems short transmission ranges (generally less than six feet). The antenna and transceiver may be located on a gasoline pumping station or other electronic sale transaction stations such as a self-serve grocery check-out line.

In still other embodiments the identifier 120 may include any device configured or adapted to generate a signal indicative of a predetermined charity that would be known by an ordinary person skilled in the art now or in the future. The signal may be an image, a radio signal, or any other signal that would be known by an ordinary person skilled in the art now or in the future.

The identifier 120 in the depicted embodiment is a separate element designed to be permanently attached to the main portion 102. In other embodiments the identifier 120 may be an integral part of the main portion 102. In still other embodiments the identifier 120 may be designed to be removed and attached to the main portion 102 by a user. In some embodiments the user may be able to purchase or obtain several separate identifiers 120, each identifier 120 designed to identify a different charity. The identifiers 120 may be interchangeable on the bracelet 100.

In some embodiments the identifier 120 may be an integral part, or attached to the decorative element 118. Thus the design of the decorative element 118 is indicative of the charity that the identifier 120 is associated with. In some embodiments both the identifier 120 and the decorative element 118 may be detachable from the main portion 102. The user may attach different decorative elements 118 and identifiers 120 to indicate which charity he/she wishes a percentage of the purchase to be donated to.

The first side portion 104 includes an inside surface 130, an outside surface 136, a first end 114 and a second end 122. The first side portion 104 is a generally elongated member. The first end 114 is curved to fit around a wrist and to facilitate holding a dispensing lever of a fluid dispensing pump in an open position as described below. The second end 122 is somewhat less curved than the first end 114. A cross section of the first side portion 104 is generally rectangular shaped with curved corners. The second end 122 is designed to fit inside the center portion 108. Thus, the cross section of the first side portion 104 is a bit smaller than the cross section of the center portion 108, and the curve of the second end 122 is similar to that of the center portion 108. The first end 114 may be curved and somewhat tapered.

The first side portion 104 includes at least one protrusion 112. Protrusion 112 includes a protruding portion 150 and a flan 148. A spring 126 biases flan 148 against the inside of first side portion 104. Spring 126 biases protruding section 150 on the outside of first side portion 104 through aperture 146. Protruding portion 150 is configured to recede into the first side portion 104 when downward pressure is applied to protrusion 112.

The second side portion 106 includes an inside surface 132, an outside surface 138, a first end 116 and a second end 124. The second side portion 106 is a generally elongated member. The first end 116 is curved to fit around a wrist and to facilitate holding a dispensing lever of a fluid dispensing pump in an open position as described below. The second end 124 is somewhat less curved than the first end 116. A cross section of the second side portion 104 is generally rectangular shaped with curved corners. The second end 124 is designed to fit inside the center portion 108. Thus, the cross section of the second side portion 106 is a bit smaller than the cross section of the center portion 108, and the curve of the second end 124 is similar to that of the center portion 108. The first end 116 may be curved and somewhat tapered.

The second side portion 106 includes at least one protrusion 112. The second side portion 106 is a mirror image of the first side portion 104.

The bracelet 100 is adjustable to fit a variety of wrist sizes and to facilitate holding a dispensing lever of a fluid dispensing pump in an open position. The protrusions 112 can be held down while sliding first ends 122, 124 into the center portion 108. When the side portions 104, 106 are in approximately the desired position, the protrusions 112 can be let to protrude through the apertures 110 in the center portion. The protrusions 112 will then hold the side portions 104, 106 in the desired position. As illustrated in FIGS. 1A and 1C a variety of positions are possible.

When pumping gas at a gas station pump, it is convenient for the customer to have a device to hold the dispensing lever on the pump handle in the open position, rather than the holding the lever the entire time gasoline is dispensed. Customers may not want to stand outside their cars in the rain or snow for long periods of time. Safety may also be an issue at night. Many pumps have such a device on them, but they are often broken. Separate devices exist to hold the lever in an open position, but they are often cumbersome and customers may forget to bring them when buying gas.

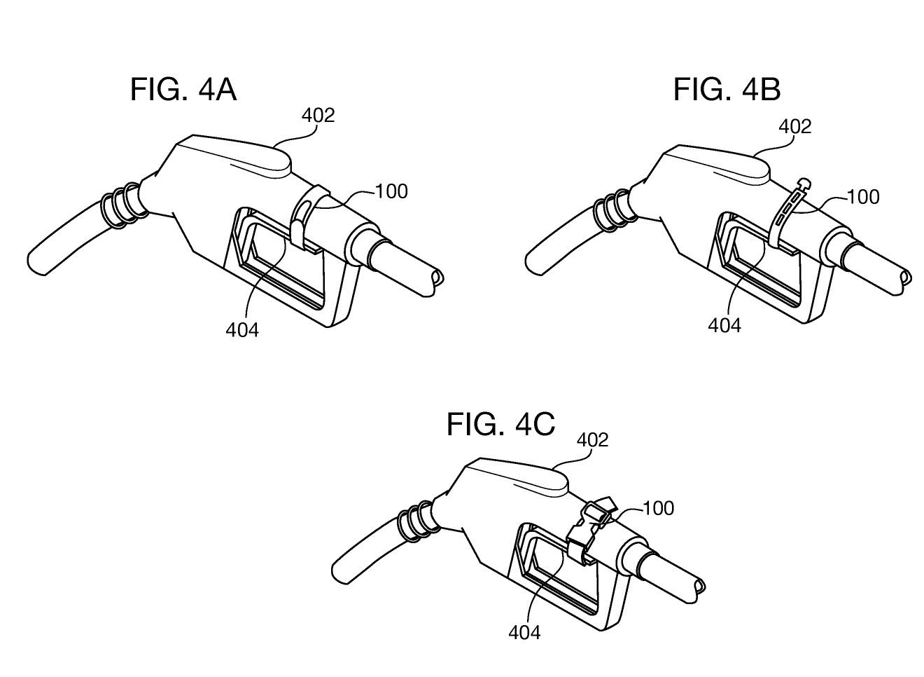

Referring now to FIG. 4A, an embodiment of a fluid pumping device 402 is depicted with a pumping lever 404 held in an open position by bracelet 100. A gasoline customer wearing bracelet 100 may utilize the bracelet to hold the pumping lever 404 in the open position. The customer may remove the bracelet from his/her wrist, hook one side portion 104, 106 one the lever 404, and then adjust the bracelet to hook the other side portion 104, 106 on the pumping device 402 to hold the lever in an open position.

The bracelet 100 may be made of a metal, plastic, or other suitable solid material as would be known by an ordinary person skilled in the art now or in the future.

An ordinary person skilled in the art now or in the future will recognize that there are many other embodiments of the adjusting mechanism of the bracelet. For example, the bracelet 100 may not include protrusions 112 or apertures 110. Alternatively, the center portion may include slits with side slots. The side portions 104, 106, may include a member which slides along the slit as the bracelet 100 is adjusted and then fits into the slots to hold the bracelet 100 in the desired position.

In another embodiment the center portion 108 may be attached to side portions 104, 106 with hinges configured to lock in several positions.

Embodiments of bracelet 100 may have different shapes and configurations as would be known by an ordinary person skilled in the art now or in the future. Additional embodiments of bracelet 100 are described below in relation to other figures. These embodiments are meant to be exemplary and non-limiting.

Referring now to FIGS. 2A, 2B, and 2C, embodiments of adjustable bracelet 100 are depicted. In these embodiments, bracelet 100 includes a main portion 218, a first end 202, and a second end 204. The main portion 218 includes a decorative element 214, an electronic charity identifier 216 and a plurality of apertures 212.

The main portion 218 includes an elongated rectangular band. Apertures 212 are rectangular shaped and closer in proximity to the first end 202 than the second end 204. The identifier 216 is an RFID tag 222 as described above. The tag 222 may be detachable or it may be integral to main portion 218.

Decorative element 214 is integral to bracelet 100. Generally, decorative element 214 a series of shapes making up a part of main portion 218. In FIG. 2A decorative element 214 is three (3) stars. In FIG. 2B decorative element 214 is three (3) Christmas trees. In FIG. 2C decorative element 214 is three (3) stick people. These are non-limiting examples. Decorative element 214 may also include the color of the bracelet 100. For example, the bracelets 100 in FIGS. 2A, 2B, and 2C may all be different colors.

First end 202 includes a guide 206. The guide 206 is rectangular in shape and includes a rectangular aperture 208. Second end 204 includes a tab 210. Bracelet 100 is made of a flexible material and is thin enough to bend easily. The material is strong enough to facilitate holding a dispensing lever of a fluid dispensing pump in an open position as described below.

To wear bracelet 100 on a wrist, bracelet 100 is wrapped around the wrist. Tab 210 is inserted through aperture 208 pulling the second end 204 through the aperture 208 to adjust the circumference of bracelet 100. When the desired circumference is achieved, tab 210 is inserted through one of the apertures 212 as can be ascertained in the drawings, then turned ninety (90) degrees to lock the bracelet 100 in that circumference.

Referring now to FIG. 4B, an embodiment of a fluid pumping device 402 is depicted with a pumping lever 404 held in an open position by bracelet 100. When the bracelet 100 is needed to hold lever 404 of device 402 in an open position, bracelet 100 may be removed from the wrist. Bracelet 100 may be wrapped around the lever 404, and secured as described above.

Referring now to FIGS. 3A and 3B, an embodiment of adjustable bracelet 100 is depicted. The bracelet 100 includes a main portion 302. The main portion 302 includes a flexible strap 312. The flexible strap 312 may be cloth, plastic, rubber, or any other material that would be flexible enough and strong enough to be adapted to wrap around a human wrist and facilitate holding a dispensing lever of a fluid dispensing pump in an open position as described below, as would be known by an ordinary person skilled in the art now or in the future. The bracelet includes a decorative element 318. The decorative element 318 may include a charm. The charm shown in the depicted embodiment includes a star. The star includes a fastening device 322. The strap 312 slides through the fastening device as shown in FIG. 3B. The decorative element 318 may include other type charms as would be known by an ordinary person skilled in the art now or in the future.

The decorative element 318 includes an electronic charity identifier 320. The electronic charity identifier may include a RFID tag 324 as described above in relation to FIGS. 1A, 1B, 1C, and 1D. The decorative element 318 and the RFID tag 324 identify a predetermined charity. Other, different decorative elements 318 including RFID tags 324 identifying other charities may be obtained with the bracelet 100. Different decorative elements 318 may be attached to the strap 312 to identify different charities. The person wearing the bracelet 100 would be able to identify the charity by the features of the decorative element 318. The RFID tag 324 would identify the charity to a merchant wishing to donate the percentage of a sale.

The bracelet 100 includes a clasp 304. The clasp 304 includes a clasping element 308 and a receiving element 306. The clasping element 308 includes prongs 316 which can be compressed with a human hand and inserted into receiving element 314. When the prongs 316 are released they catch portions of receiving element 314 and lock the clasp 304.

Bracelet 100 is adapted to be wrapped around a human wrist and secured with clasp 304. Bracelet 100 includes adjusters 310. The ends of the strap 312 are inserted through adjusters 310. After bracelet is secured around a human wrist, one or both of the adjusters 310 may be used to adjust the bracelet to fit.

Referring now to FIG. 4C, an embodiment of a fluid pumping device 402 is depicted with a pumping lever 404 held in an open position by bracelet 100. When the bracelet 100 is needed to hold lever 404 of device 402 in an open position, bracelet 100 may be removed from the wrist. Bracelet 100 may be wrapped around the lever 404, secured, and adjusted as described above.

Other aspects, objects and feature of the present invention can be obtained from a study of the drawings, the disclosure, and the appended claims.

What is claimed is:

1. An adjustable bracelet, comprising:
an adjustable main portion adapted to be worn on a human wrist; and
an electronic charity identifier attached to the main portion; and
wherein the bracelet is adapted to hold a dispensing lever of a fluid dispensing pump in an open position.

2. The bracelet of claim 1, further comprising a decorative element attached to the main portion.

3. The bracelet of claim 2, wherein the identifier and the decorative element identify a predetermined charity.

4. The bracelet of claim 1, wherein the main portion includes a flexible strap.

5. The bracelet of claim 4, wherein the main portion includes a predetermined color and the identifier and the color identify a predetermined charity.

6. The bracelet of claim 4, further comprising a strap adjuster.

7. The bracelet of claim 4, further comprising a adjustable closing mechanism.

8. The bracelet of claim 1, wherein the main portion includes a solid material and an adjustable mechanism.

9. The bracelet of claim 1, wherein the main portion includes:
a first end adapted to hook around the dispensing lever; and
a second end adapted to hook around a handle of the fluid pump.

10. The bracelet of claim 1, wherein the identifier includes a barcode indicative of a predetermined charity.

11. The bracelet of claim 1, wherein the identifier includes a RF component operable to produce a signal indicative of a predetermined charity.

12. The bracelet of claim 1, wherein the identifier includes a selector configured to allow selection of one of a first charity and a second charity.

13. The bracelet of claim 1, wherein:
the identifier includes one of a first charity identifier and a second charity identifier; and
the identifier is removable from the main portion.

14. An adjustable bracelet, comprising:
an adjustable main portion adapted to be worn on a human wrist, the main portion including an electronic charity identifier; and
wherein the bracelet is adapted to hold a dispensing lever of a fluid dispensing pump in an open position.

15. The bracelet of claim 14, further comprising a decorative element attached to the main portion.

16. The bracelet of claim 14, wherein the main portion includes a flexible strap.

17. The bracelet of claim 16, further comprising a strap adjuster.

18. The bracelet of claim 16, further comprising an adjustable closing mechanism.

19. The bracelet of claim 14, wherein the main portion includes:
a solid material and an adjustable mechanism.
a first end adapted to hook around the dispensing lever; and
a second end adapted to hook around a handle of the fluid pump.

20. The bracelet of claim 1, wherein the identifier includes a barcode indicative of a predetermined charity.
